(19) United States
(12) Patent Application Publication
(10) Pub. No.: US 2003/0232952 A1
(43) Pub. Date: Dec. 18, 2003

(54) Design and synthesis of instant - degradable plastics

(76) Inventor: Oren Rosen, Jerusalem (IL)

Correspondence Address: Rashida A. Karmali, PhD, 13th Floor, 99 Wall Street, New York, NY, 10005, US

(21) Appl. No.: 10/465,306

(22) Filed: Jun. 19, 2003

Related U.S. Application Data
(63) Continuation-in-part of application No. 09/776,284, filed on Feb. 2, 2001, now abandoned.

(51) Int. Cl. C08G 18/00; C08G 63/00

(52) U.S. Cl. 528/44; 528/271; 528/373

(57) ABSTRACT

A novel class of instant degradable synthetic polymeric plastics having the characteristics and properties of conventional forms of plastics is developed by providing a new application advantage of incorporating latent, labile, dormant chemical bond nuclei such as disulfide and sulfenyl derivatives of the plastic compounds with latent nucleophilic properties. The special advantage of the instant degradable polymers over the existing biodegradable and other degradable polymer counterparts, is their engineering and design, which makes the kinetics of their degradation instant, and the chemical and physical properties of their by-products allows soluble dissolution into non-toxic aqueous solvent media, thus enabling a practical treatment of waste and avoiding bio-hazardous pollution of the environment. These novel plastic products are made from a variety of compositions of polymers and their compatible nontoxic modifiers. The resulting novel instant degradable plastic products retain latent dormant solubility properties that are triggered upon mild chemical reaction, thus enabling cost effective and facile recycling of plastic refuge.

### 1. CROSS-REFERENCE TO OTHER APPLICATIONS

This application is a Continuation-in-part of pending U.S. patent application Ser. No. 09/776,284, filed on Feb. 2, 2001, and incorporated herein in its entirety.

### 2. FIELD OF INVENTION

This invention relates to a novel class of instant degradable synthetic polymers having the characteristics and properties of conventional plastics and synthetic methods, which require minimal modification of current industrial machinery and production infrastructure. The present invention takes a novel approach to addressing the problem of disposing and degrading various types of plastics, by actually designing instant degradable polymers. The present invention provides the design, logic, rationale, synthesis and production of a family of special plastics-retaining the original mechanical properties as specified in existing product development of plastics and polymers, on the one hand, while incorporating new and additional orthogonal chemicals for obtaining properties as parameters to existing types of plastics, thus supplying a new dimension of potential product specifications. Specifically, this application presents with a new important approach for practical waste-disposal of environmentally contaminating plastics, which are chemically and instantaneously degraded in a controlled manner, within a span of twenty four hours, into a convenient processing environment for their disposal, or re-use in the existing industrial socio-economical framework. The description of the visual phenomenon named as Instant Degradation process (as described to one of ordinary skill) is unique in the management of plastics disposal management, and may be described as in analogy for plastics waste-disposal management by the preferential instant dissolution of non-toxic sugar in comparison to completely insoluble toxic plastics in water. Other descriptive synonym terms may be described for the application and utilization of such a chemical phenomenon and process in plastics such as “Instant Vanishing Plastics” or “Instant safe disposal of plastics by rapid, and instant dissolution”. The materials phenomenon that happens is a dissolution of Instant Degradable Plasticsas solid-phase polymers, and occurs by a chemical reaction between the solid-phase polymer with latent labile dormant bonds and soluble nucleophilic reagent in the liquid phase as is reported in chemical literature for solid phase synthesis, to obtain soluble degradation products, which enhance the observed phenomenon described above (similar to dissolution of sugar into water). The chemical difference in the requirement for homogeneous dissolution of ID polymeric Plastics and the existing state of the art on Solid Phase Peptide Synthesis or combinatorial Chemistry for such an application, may be caused, among other factors which are dependent on the degrading component additive, is that in regular SPPS there is a large bulk polymer with non-degradable chemical domains, which are insoluble as in the existing Plastics, whereas in IDP of this invention most of the SPP contains a homogeneous dispersion of the chemical nuclei which enable it to instantly degrade and dissolve homogeneously.

In contrast, prior art only describes bio-degradable plastics by partial and slow degradation of the existing plastics, which pose problems related to the accumulation of bio hazardous biomass formed when such plastics are decomposed (if at all) by micro-organisms, thus posing an environmental hazard. The present invention overcomes this problem by designing instant degradable plastics having properties similar to those of the existing conventional plastics, which are described in the prior art and some of which are completely and practically insoluble in water and pose a serious hazard to the environment. In addition to retaining similar existing beneficial mechanical properties of prior art plastics, these instant degradable plastics contain additional intrinsic inactivated dormant latent labile chemical bonds within the plastics macromolecules. Some example polymers described below have the advantage of having the appropriate and preferential disintegration kinetics for the applied instant degradable plastics over the existing state of the art plastics in the above-mentioned application. In addition, this quality, among other chemical system qualities may be attributed to specially designed degrading reagents, which perform an improved and preferential mild and environmentally friendly nucleophilic chemical cleavage of the above-mentioned pre-designed and specially designed labile latent chemical bond nuclei within the instant-degradable macromolecular polymeric substances comprising the ‘Instant Degradable Plastics’.

Another chemical approach for achieving the above concept by introducing dormant “pre-activated” labile latent chemical bond nuclei” which upon oxidation by a simple chemical reagent, such as hydrogen peroxide, yield an activated labile dormant latent chemical carbon nuclei which cause the non-degradable chemical reaction transformation of a non-degradable chemical reaction transformation of a solid-phase matrix into a preferably non-toxic aqueous mixture of products similar to the dissolution of sugar into water. The instant degradable (ID) polymers can be created by a combination of these kinds of pre-activated dormant materials, together with orthogonal and regular labile latent chemical bond nuclei to control and direct the process of ID of plastics. The compositions of instant degradable polymers can be created by a combination of these kinds of pre-activated dormant materials, together with orthogonal and regular labile latent chemical bond nuclei to control and direct the process of instant degradation of derived plastics.

Thus, this process yields preferentially in most cases, non-toxic reaction mixture of degradation products, which can be easily handled, processed, and optionally recycled. The soluble non-toxic degradation products from the instant degradable plastics have practical industrial and technological and possibly economical advantages over existing degradation techniques of plastics for waste disposal Specifically, the present invention provides a realistic cost effective and easy method to prepare substitute monomers and polymers in the conventional existing industrial processes which are degradable and can substitute non-degradable compositions of similar plastics. Examples of instant degradable plastics comprise specific illustrative examples including latent labile amino-sulfenyl, oxygen-sulfenyl, disulfide, or ester chemical nuclei moieties, within the polymer macromolecular composition of plastics. These moieties serve as essential labile bonds for the performance of instant degradation and solubilization of the ‘Instant-Degradable Plastics’ into practical disposal processing similar to the observable chemical phenomenon of the instant dissolution of non-toxic sugar into aqueous solutions within a span of about 24 hours.

This is a new and unique prerequisite requirement for defining the applicability of any existing candidate polymeric substance as ‘instant-degradable polymers’. Some existing prior art polymeric substances may mistakenly be considered as containing the above mentioned chemical latent bond nuclei and representing the prior art for ‘bio-degradable polymers’. However, it can easily be experimentally proven that these prior art examples do not fit the required definitions of instant degradable polymers. The definition of ‘instant degradable polymers or plastics’ requires that these plastics will dissolve rapidly, instantaneously, and practically be dissolved into an aqueous solution as a non toxic sugar would in water, and preferably for their degradation to not toxic soluble products. Thus, the present invention overcomes the disadvantages in existing disposal processes of existing plastics, and provides solutions to problems encountered in the plastic industry in the context of waste disposal and ecological problems.

### 3. BACKGROUND OF THE INVENTION

It would be difficult to imagine a world without plastics. Among the most versatile materials ever developed, plastics can be made to resemble and even replace such diverse materials as metal, wood, glass, china, stone cloth, rubber, jewels, glue, cardboard, varnish or leather. As many as fifty or more types of plastics exist, with new ones being developed as research continues. Different plastics are used for different purposes, but most of them tend to be strong, durable, lightweight, and resistant to corrosion. They are often less expensive than other materials and can be made in a variety of colors.

Plastics and other polymers are in theory recyclable, but after a relatively short functional life, are destined to arrive as a significant component of trash. Most of these plastics and other polymers disposed of in landfills are chemically stable and degrade minimally. The problem also arises of what to do with millions of tons of plastic waste. In response, the plastic industry and environmental groups are studying ways to recycle plastics. Some plastic objects can be ground up and reprocessed into new products. For example, soft drink bottles made of polyethylene terephthalate (PET) and high-density polyethylene milk jugs have been refabricated into such products as filler for down jackets and sleeping bags, insulation, strapping materials and plastic lumber. The effects of plastics on the environment go beyond the issue of recycling. Insoluble plastics are constantly accumulating globally and causing hazardous damage to many biological ecosystems.

As a commercial example, the Society of the Plastics Industry Inc., reported that 10,375 million pounds of resin were sold domestically for production of films in 1994. This creates the necessity for the safe disposal of these films into the environment. It is important to note that the polyethylene (PE) family of plastics accounts for about 86 percent of commercially sold resin for plastic films. Linear low density polyethylene (LLDPE) composed 36.6 percent of the resin sold for film applications. LDPE accounted for 34.8 percent and high density polyethylene accounted for 15 present. The remaining 14 percent of the plastic films was made from polypropylene at 8.9 percent, polyvinyl chloride at 3.7 percent and nylon at 1 percent. There is therefore, an urgent need to develop products that include the Instant Degradable Products of the present invention to ensure that the massive amounts of polyethylene and other plastics mentioned above can be degraded into non-toxic products and disposed of safely.

This is an increasing problem of plastic pollution in the environment, while the demand for plastics keeps on increasing in most consumer products. Furthermore, the availability of landfill space is diminishing, while there is a worldwide trend toward more stringent regulatory requirements on landfills and waste disposal. Some research and commercial efforts have been directed toward the development of new uses for polymerized products such as scrap, waste tires or rubber. However, because of the high costs associated with the use of plastics this approach has not gained wide acceptance. It is therefore necessary to develop alternative pathways for production of a new class of plastics and a considerable amount of attention has been devoted towards recycling and reclaiming plastics and other polymers.

There are two broad groups of polymers and copolymers classified according to their polymerization: a) condensation polymers, for example polyesters, nylons or polycarbonates, and polyurethane having a polymerized form with a lower molecular weight than the sum of monomers used to make them, and b) chain growth or addition polymers, such as polyethylene, polystyrene and polypropylene that have the same molecular weight as the sum of the monomers used to make them, and are made in specific conditions of temperature and pressure and in the presence of a catalyst. However none of these polymers have the unique properties and characteristics of the “Instant Degradable Plastics” of the present invention. And none of the current polymers on market are instant degradable and manufactured on an industrial scale in large quantities.

The currently existing industrial approach to the degradation of plastics and polymers is to generally break down these contaminants by two ways: pyrolysis and depolymerization. Pyrolysis requires high temperature conditions known as thermal cracking, a process in which polymer molecules are heated until they fragment into several smaller and randomized-sized molecules, which might cause serious air-pollution. For example, a mixture of alcohols or hydrocarbons, none of which is an original monomer and may not be recycled into fine chemical or fuels.

De-polymerization is carried out at significantly milder thermal conditions than those employed in pyrolysis and prior art teaches several hydrolytic methods, for example, glycolysis, methanolysis or hydrolysis, based on the depolarization reagent used, such as glycol, methanol, or water respectively, wherein under specific conditions of temperature and pressure, with or without a catalyst, the polymer chain separates into original monomers. However, this approach is not a practical one for the bulk of plastics because of solubility problems for the reaction medium, or for the accumulation of biohazardous materials as a result of bio-degradation.

U.S. Pat. No. 5,453,457, issued to Meltzer et al, describes “Gamma-Radiation—Resistant Polycarbonate Composition” containing disulfide esters alone or as a co additive with a polyether the polycarbonate is rendered more resistant to the deterioration resulting upon exposure to gamma radiation. Meltzer describes the composition of a polycarbonate that increases the resistance to its deterioration, and not one that facilitates its degradation into possibly non-toxic by products, as in the present invention. The present invention in combination with the co-pending U.S. patent application Ser. No 09/779,056 (and incorporated herein as a reference in its entirely) is a significant improvement over Meltzer, and provides practical advantages in dealing with the solubility (not mentioned in Meltzer) for such problematic plastics. In contrast to the technical objective posed by Meltzer (to increase the resistance to degradation), the present invention provides new and useful designs to generate “Instant Degradable Plastics” with their advantages, and useful applications, and solutions to industrial waste disposal of other kinds of ecologically hazardous plastics, which are not mentioned in the Meltzer patent. The present “Instant-degradable Plastics” can be processed into preferentially low-molecular non-toxic products under relatively simple, cheap, and non-severe conditions for large scale mass processing in mass production of plastics problematic in waste disposal issues.

WO 00/71180 A1 to Nancy Marchant, describes “Bioadhesive Hydrogels with Functionalized degradable Crosslinks” having a composition comprising two or more essentially extractable, essentially non-degradable polymer backbones, that are crosslinked and only degradable inside the body of a mammal by enzymatic cleavage, exchange reactions with mucin, reduction and oxidation.

Marchant's hydrogels themselves do not have the properties of conventional plastics and importantly, cannot be degraded into non-toxic by products by simple chemical procedures as in the present invention. The Marchant hydrogels are not mechanically adapted for use as other existing plastics products reported, in prior art, nor comparable to the common plastics. Instead they are “Instant and conveniently” degraded into disposable non-toxic degradation products by mammalian enzymatic cleavage exchange reactions in mucin by ‘reduction and oxidation’. Due to the existence of proteins in the degradation medium, the degradation requires special sterilization precautions against bio-hazards and uncontrolled microbiological growth-thus excluding their practical use. In addition, many solubilization problems of Marchant's plastics pose technical problems for bulk mass application. These disadvantages have been overcome in the design of the “Instant degradable plastics”.

U.S. Pat. No. 5,026,821, issued to Boustta et al describes “Polymers of Citric Acid and Diamines, a Process for their Preparation and their uses, in Particular as Carriers of Drug”. The polymers are hydrophilic and composed of polyamides resulting from the condensation of citric acid with diamines (which can be simple aliphatic or aromatic diamines such as ethylene diamine, hexamethylene diamine, 3,6 dioxa-1,8-octyldiamine, cystamine or phenylenediamines. Boustta's polymers are hydrophilic, soluble in water to varying degrees, and although they can be degraded in the body by hydrolysis to citric acid and L-lysine, lack the mechanical, chemical and degradability properties of the present invention. There is an essential toxicity problem posed by use of this chemical example. Specifically, it is known that Cystamine (as a possible degradation product component to these Polymers) is toxic above a 0.5% concentration in aqueous solutions by FDA regulatory Law. This eliminates the practical use of any such polymer as a defined substance nominated in the “Instant-Degradable Polymer” for the application in plastics.

H. Tsutumi et al, describe in their Article in Material Research Society Symposium Proceedings Vol 496, 323-328 (1998) entitled “Application of Potentially Biodegradable Polyamide and Polyester Containing Disulfide Bonds to Positive Active Materials for Lithium Secondary Batteries”, biodegradable polyamide and polyester having disulfide moieties. However, the reference describes that degradation of both polymers was slow: 1800 days and 630 days, a disadvantage overcome in the present invention, which requires the “Instant dissolution of the commonly used Plastics in water, similar to the phenomenon of the instant dissolution of non-toxic sugar upon the addition of its crystal (solid state) into water.”

A number of compounds with carbon-carbon double bonds are used in the prior art and the present state of the art preparation of polymers. Alkenes of the type CH₂═CH—X are used to form polymers of the type

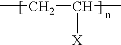

shown below in Table A.

TABLE A
Alkenes of the type CH₂═CH—X used to form polymers of the type

| 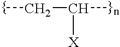 | R, R¹ | | |
|---|---|---|---|
| Ethylene | CH₂═CH₂ | —H | Polyethylene films as packaging |
| | | | material; “plastic” squeeze bottles are |
| | | | molded from high density polyethylene |
| Propene | CH₂═CH—CH₃ | —CH₃ | Propylene fibers for use in carpets |
| | | | and automobile tires; consumer items |
| | | | (luggage, appliances, etc); packaging |
| | | | material |
| Styrene | CH₂═CH-benzene | -benzene ring | Propylene packaging, housewares, |
| | ring | | Luggage, radio and television cabinets |
| Vinyl chloride | CH₂═CH—Cl | —Cl | polyvinyl chloride (PVC) has |
| | | | Replaced leather in many of its |
| | | | applications; PVC tubes and pipes |
| | | | Are often used in place of copper |
| Acrylonitrile | CH₂═CH—C═N | —C═N | Wool substitute in sweaters, blankets |

Alkenes of the type CH₂═C×2 are used to form polymers of the type (—CH₂—CX₂—)ₙ shown below in Table B.

B. Alkenes of the Type CH₂═CX₂ used to form polymers of the type (—CH₂—CX₂—)ₙ

| Compound | Structure | X in polymer | Application |
|---|---|---|---|
| 1,1-Dichloroethene | CH₂═CCl₂ | Cl | Saran used as air- |
| (vinylidene chloride) | | | and water-tight |
| | | | packaging film. |
| 2-Methylpropene | CH₂═C(CH₃)₂ | CH₃ | Polyisobutene is |
| | | | component of |
| | | | “butyl rubber, ” |
| | | | one of earliest |
| | | | synthetic rubber |
| | | | substitutes. |

Other chemical structures may also be used to form polymers as shown below in Table C.

C. Others

| Compound | Structure | X in polymer | Application |
|---|---|---|---|
| Tetrafluoroethene | CF₂═CF₂ | (—CF₂—CF₂—)ₙ(Teflon) | Nonstick coating for cooking utensils |
| | | | bearings. gaskets, and fittings. |
| Methyl methacrylete | 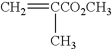 | 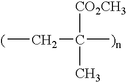 | When cast in sheets, is transparent; used as glass substitute (Lucite, Plexiglas). |
| 2-Methyl-1,3-butadiene | 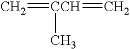 | 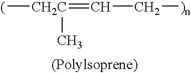 | Synthetic rubber. |

Source: R. C. Atkins and F. A. Carey, Organic Chemistry: A Brief Course, McGraw-Hill, New York, 1990, p. 132.

Generally fifty percent or over, of the manufactured polymers are used as packaging materials and about ninety percent of this flow finishes as a component of ecological garbage. Much effort has been put into developing synthetic polymers intended for packaging, which are capable of being broken down chemically and physically by environmental actions or by biological processes. Such polymers are described as biodegradable.

Biodegradability can be defined as a catalyzed degradation of polymers at the molecular level of substances by the action of enzymes derived from the metabolic processes of microorganisms. The synthetic polymers may also be collected in a reservoir containing bioactive bacteria and microbes, which degrade the plastics to environmentally non-toxic degradation products. However, problems exist in the recycling and purification of monomer degradation products because these products may not be reincorporated into plastics in a cost-effective process. Moreover, the degradation process is time consuming and bio-hazardous, and often results in accumulation of heaps of hazardous garbage.

Some polymers are known to degrade by hydrolysis in the presence of water and thereby decompose to smaller chemical units. Some of these polymers are also biodegradable, such as polylactic acid and polyglycolic. Due to the expense and difficultly in preparing these hydrolytically degradable polymers, their use has been largely confined to high cost medical applications where bioabsorbable materials are required.

The object of the present invention is to provide cost effective and easy to prepare instant degradable compositions of monomers, polymers and plastics of all types containing such intra molecular bonds as the amino-sulfenyl (═—NH—S—), the oxygen sulfenyl (═—O—S—), the disulfide (═—S—S—) moieties, intramolecularly degradable polyester moieties thus enabling special pre-activation degradation processes for problematic plastics and ways to develop processes for their production in order to enable these compositions to be used as instant degradable plastics.

### 4. SUMMARY OF INVENTION

The present invention describes polymeric macromolecules, named as “Instant-degradable Plastics” herein. Their practical use is intended to solve waste disposal problems, by providing a variety of modified classes of polymers. Specifically the degradable materials are non-toxic and chemically degradable through a mild and aqueous nucleophilic cleavage of labile intramolecular bonds in the polymeric macromolecule solid phase materials. Specifically, the cleavage is produced by reacting a monomer with the suitable modifier monomer building unit. The materials selected comprise: amino sulfenyl, oxygen sulfenyl, inert disulphide, or dormant ester bonds. This is because the monomer (diolic or dithio, or any combination of aminosulfenyl, hydroxy thiol or amino thiol diamino units) must have a chemical moiety that can provide the suitable mechanical qualities to the instant-degradable plastics of the invention. These properties are similar for casting and production of plastics products. The modifier monomeric building unit of the Plastics product provides, for example, a disulfide moiety (or other chemically labile latent chemical bonds, which are inert and lie dormant during the usual specified period of time of use of the plastics. But, unlike the existing plastics of the prior art, the present instant degradable plastics can be disintegrated by instant degradation, followed by a convenient dissolution of the plastics into a non-toxic aqueous solution within a span of about 24 hours. The phenomenon is similar to that of the dissolution of non-toxic sugar into aqueous solution).

The compositions of the present invention are made by a combination of both the monomer and the modifier monomer (or only the modifier monomer as a substitute to the regular monomer) are required to compose and prepare (in the existing polymerization processes, or to mildly adapted modified industrial processes) the instant-degradable plastics that could eventually be converted to non-toxic chemically degradable products. The modifier “Instant-Degradable Polymeric” monomeric building unit is compatible with existing polymer syntheses and is of nonvolatile and nontoxic qualities. Various materials can be made into “Instant-Degradable Polymers” and are produced from the modifier monomeric building units in combination, or separately with the existing monomers described in prior art (which enhance desired mechanical properties to both the plastics as mentioned in the prior art, as well as in Instant degradable Plastics). They include films, molded products, laminates, foams, powders, nonwovens, adhesives, and coatings, polymers for combinatorial plastics—such as polymers for used as matrix reagents in solid state with the use of a liquid state containing special chemical reagents used in organic synthesis, polymers for solid phase peptide synthesis etc. Polymer Matrices for DNA and RNA synthesis etc., electronic circuits, microchip matrices, etc. The degradable polymers of the present materials are typically hydrolytically degradable, after chemical activation (such as by oxidation with Hydrogen Peroxide, etc.) of special dormant in—active latent bonds—thus transforming them to active labile bonds which can be hydrolytically cleavable bonds for the Instant-degradable Polymer applications, and/or are degradable under reducing conditions, because of the presence of latent amino sulfenyl, oxygen sulfenyl disulphide functional groups of the polymer. The modifier is nonvolatile and typically has a vapor pressure of less than about 158-163° C./3.5 mm Hg Torr at 180° and a boiling temperature above about 280° at 1 atmosphere. Importantly, the instant degradation can be applied to thermoplastic as well as thermoset polymers including, but not limited to, polyurethanes, unsaturated polyesters or epoxy resins. By incorporating such dormant “Instant-degradable chemical bond nuclei” of orthogonally labile latent bonds in the polymeric macromolecules, such as the latent amino sulfenyl, oxygen-sulfenyl disulphide bonds into thermoplastic and thermoset resins, it is possible to allow their solubilization them, under defined instant controlled conditions, preferably under aqueous conditions while they are highly insoluble as regular polymeric resins and can then be applied for further recycling and disposal. Also, by varying several types of orthogonal cleavage nucleophilic labile latent dormant bonds the process may be directed to obtain selective cleavage, leading to various types of fine chemicals according to market demand or for adaptation to processing restrictions.

The degradable materials of the present invention are useful for the production of commercial and consumer products. Such products include, but are not limited to, products for controlled release of chemicals, oral drug delivery products, automobile products, gardening products, consumer products, health products, substrates that are suitable for the attachment and growth of living cells, construction products, adhesive products, absorbent articles, flammable products, lubricants, bags, netting, rope, coatings, filters, containers, packaging, clothing, and paper goods. The degradable materials of the present invention are particularly useful for the production of frequently littered products such as, drink containers, labels, food packaging, printed matter, construction material and vehicle supplies.

The present invention is also directed towards processes for making the various degradable materials of the present invention. The process includes forming a composition, which includes a nontoxic hydrolytically degradable polymer and a nontoxic modifier, wherein the modifier is compatible with the polymer, into various materials of the present invention under conditions such that the modifier is substantially nonvolatile and nonfugitive.

The principal objectives of this invention are 1) to define and provide illustrated examples for the invention with substituted disulfide amino sulfenyl, oxygen sulfenyl and dormant ester bonds in plastic products which have comparable utility to currently produced various types of plastics, and have the advantage over the latter because of the ease with which they can be degraded using appropriate machinery and plant structures, and 2) to provide an environmentally acceptable and economically feasible process, whereby the monomeric units and/or their other useful degradation product units, from which plastics are made can be recovered for environmentally beneficial and commercially profitable applications and reuse.

A further objective is to apply de-polymerization technology to cause the polymer molecules to break down into environmentally friendly molecules, and possibly by recycling them into monomers, molecules from which they were made (but it is not a mandatory condition), i.e. production of monomeric units or their non-toxic modifiers, with an inert disulphide, amino sulfenyl, oxygen sulfenyl, or dormant ester bonds can be re-cycled in controlled industrial processes.

An additional objective is to simplify and to improve the process and for the final plastic product recovery, by adding a step for removal of interfering complex chemical additives from the plastic products, and by optimizing the reaction conditions for the fracturing of the chemical bonds within the polymer.

An additional objective of this invention is to provide a useful and cost effective solution for new machinery necessary, in the application of the processes of the present invention, by employing comparable and compatible hardware and procedures to those used in current industry practice. The main technological difference between the existing processes and the newly proposed processes of the present invention, is in the introduction of new chemical monomer formulations which sustain the defined instant-degradability properties defined in this invention, while retaining the useful mechanical properties of plastics for constructive and safe commercial applications. This may facilitate the introduction of the invention industry-wide at economically attractive terms, while remaining environmentally friendly.

An additional objective of this invention is to overcome problems of scaling up of bulk, and recycling processes to satisfy production capacity requirements by employing up to two or more moderately sized polymerization reactors operating simultaneously under similar process conditions.

Another objective of this invention is to provide a process whereby the reclamation of waste polymers does not contribute pollutants to the atmosphere, as do some other procedures currently used in burning tires to produce energy allowing to diminish their devastating accumulation, and health hazard securing their compartmentalization, saving and cutting energy costs, directing recycling processes and reusing the degradation products.

It is also an objective to produce especially designed monomers and combinations thereof, to provide instant-degradable plastics with desirable properties such as resistance to heat, toughness and flexibility.

Another objective of this invention is to provide a process, which will provide reusable monomers at a cost lower than the cost of manufacturing fresh plastic monomers from crude oil and natural gas.

It is important to note that these and other objectives of this invention are accomplished, in a broad aspect, by providing examples such as those of disulphide amino sulfenyl, oxygen sulfenyl and dormant latent labile ester bonds—containing derivatives of plastic products in general, and by showing useful, simple, mild chemical nucleophilic degradation process schemes for these plastic products in environmentally friendly conditions.

### 5. DETAILED DESCRIPTION OF THE INVENTION

Additional objects, features and advantages of the present invention will become apparent by referring to the following description of the invention in connection with the accompanying drawings.

The invention is directed to a variety of instant degradable plastic products, which contain the disulphide forms, (and other chemically different examples) and are chemically involved or as other possible examples directly or indirectly enabling facile intramolecular decomposition by chemical decomposition, leading to their instant degradation which is comparable to the phenomenon of the dissolution of non-toxic sugar into water. The basic processes for the degradation of the plastic products are for the most part identical, however, the chemical processes explaining the applicable phenomenon may be different and can be adapted to specific kinds of plastics. For example, in some instances such as in polystyrene, a different chemical polymeric structure system is used to achieve the catalytic instant-degradation quality described in the present invention, in order to accomplish the general objectives of the present invention. Thus, although waste plastics can be degraded according to the present invention, for simplicity reference is only made to the processing of used plastics, including, but not limited to, nylons, polyurethanes, polyethylene, polyesters, polyamides, or polystyrenes. The technology applies to all of the different fifty or so types of plastics that are currently available. The technology applies to all of the different fifty or so types and motifs of plastics that are currently available in Prior art.

The modifier or building unit which is used for preparing the instant degradable polymers is compatible with the polymer and is nonvolatile and nonfugitive. The various materials of the present instant degradable polymer plastic compositions of the invention include films, molded products, laminates, foams, powders, nonwovens, adhesives and coatings. The instant degradable materials of the present invention are necessary for the production of commercial and consumer products with instant degradable plastics. Such products include, but are not limited to, products for controlled release of chemicals, oral drug delivery products, automobile products, gardening products, consumer products, health products, substrates that are suitable for the attachment and growth of living cells, construction products, adhesive products, absorbent articles, flammable products, lubricants, bags, netting, rope, filters, inks, containers, packaging, drink containers, labels, food packaging, pharmaceutics and construction supplies.

The present invention is also directed towards processes for making the various degradable materials of the present invention. The processes include forming a predetermined, pre-designed composition, which includes a nontoxic, hydrolytically degradable polymer with the desired mechanical and commercial specifications, and a nontoxic modifier (building unit containing labile latent dormant bonds), wherein the modifier is compatible with the polymer, into the various materials of the present invention under conditions such that the modifier is substantially nonvolatile and nonfugitive. As used herein, “degradable” with reference to the various materials of the present invention refers to a material including a degradable polymer as described below. The term “degradable” with reference to a polymer, refers to a polymer having a polymer molecular structure which can decompose to smaller molecules. As discussed below, the degradable polymer can be chemically degraded by a fast chemical reaction between the polymer, nucleophilic reagents react under mild aqueous conditions with minimal requirement for purification processes to form two or more low molecular weight degradation products-derived from the polymer. A mild nucleophilic chemical reaction process can degrade the degradable polymer. As an example for such a process, non-toxic reducing thiols can be used to cleave latent disulphide bonds in the above-mentioned family of instant-degradable polymers, in order to induce a catalytic disassembly and dissolution of plastic product into aqueous solution.

The degradable polymers of the present invention further can be made degradable within a short time frame (of about 24 hours) in which products made from the materials, after use, can either be readily recycled by decomposition of the instant degradable polymer into monomeric units or, if disposed of into the environment, such as in landfills, the instant degradable polymer degrades quickly enough to avoid significant accumulation of polluting reagents, and is significantly less than that of similar products which are not degradable. The materials of this invention degrade instantly or in a time period of a few hours, whereas similar mass-produced, non-degradable products require typically, several days, or decades to centuries.

Reducing agents used in the present invention for the degradation of target polymers include, but are not limited to, 5-mercapto-indirubin; 2-mercaptobenzimidazole, 2-mercapto-5-benzimidazole sulfonic acid sodium salt dihydrate; 2-mercaptobenzoic acid or thiosalicylic acid; 3-mercaptobenzoic acid; 4-mercaptobenzoic acid; 2-mercaptobenzothiazole; 2-mercaptobenzooxazole; 2-mercaptoethanesulfonic acid sodium salt; 2-mercaptoethyl trimethyl ammonium bromide acetate; 2-mercaptoethyl trimethyl ammonium iodide acetate; 2-mercaptoimidazole; 8-mercaptomenthone; 2-mercapto-5-methylbenzimidazole; 2-mercapto-1-methylimidazole; mercaptomenthone; 5-mercapto-1-methyltetrazole; 2-mercapto-5-methyl, 1,3,4-thiadiazole; 3-mercapto-4-methyl-4-H-1,2,4 triazole; 3 mercaptopropanediol; 3-mercapto-1-propane sulfonic acid sodium salt; 3-mercaptopropionic acid; n-2-mercaptopropionyl glycite; meraptosuccinic acid; 2-mercaptoacetic acid; cysteine, glutathione and other cysteine containing peptides, sodium borohydride; or sodium cyano borohydride; mercaptopyruvic acid sodium salt.

Reducing agents having the thiol group or mercapto compounds in general, can be incorporated into polyionic, non-toxic bimolecules in order to retain the specified reducing conditions for instant-degradable polymers on the one hand, while enabling non-toxic disposal and handling of the polymeric degradation products, for example

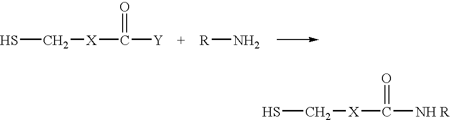

Where x=1-6, Y=activating group, R=peptide, sugar, other molecules.

The thiolic nucleophilic examples include, but are not limited to, 6-mercaptoguanosine; 8-mercaptoguanosine; 2(R)-2-mercaptomethyl-4-methylpentanoyl-β-(-2naphthyl)-ala-ala-amide; (2R)-2-mercaptomethyl-4-methylpentanoyl-phe-ala-amide; N-(2-mercaptopropionyl)-glycine; 2-mercaptopurine; 6-mercaptopurine; 6-mercaptopurine-2′-deoxy-riboside; 6 mercaptopurine riboside; B-mercaptovaline or mercaptoindirubin. Generally, the mercapto compounds can be incorporated into polyionic (non-toxic) biomolecules to retain reducing conditions and to enable non-toxic disposal and handling of the polymeric products.

The degradation characteristics of the polymer in the present materials depend in large part on the type of material being made with the polymer. Thus, the polymer needs to have suitable degradation characteristics so that when produced into a final material, the material does not undergo significant degradation until after the useful life of the material. Therefore, different embodiments of the present invention will have different degradation characteristics. The instant degradable plastics may also be biodegradable.

Monomer precursors for incorporating latent disulphide nuclei in the instant degradable polymers of the present invention include:

HO—(CH₂)₂—S—S—(CH₂)₂—OH; H₂N—(CH₂)₂—S—S—(CH₂)₂—NH₂

HO—(CH₂)₂—S—NH—(CH₂)₂—OH; HO—(CH₂)₂—S—O—(CH₂)₂—OH

H₂N—(CH₂)₂—S—NH—(CH₂)₂—NH₂; H₂N—(CH₂)₂—S—O—(CH₂)₂—NH₂

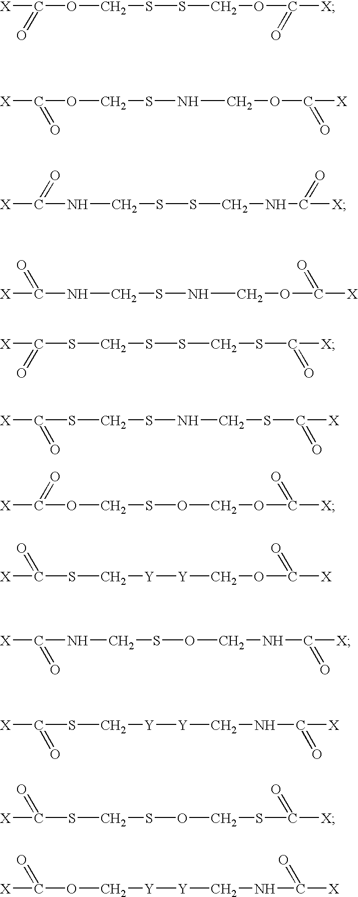

where Y—Y═—S—NH; —O—S—; or 2,2′-Dithiosalicylic acid and its derivatives and X═CH2═CH2, CH2═CH—CH3, CH2═CH-benzene ring, CH2═CH—Cl.

An instant degradable plastic product is described comprising a hydrolytically degradable polymer and modifier, wherein said modifier is compatible with said polymer and is non-volatile and non-fugitive and wherein said polymer comprises repeating monomer units selected from the group consisting of:

| | |
|---|---|
| HO—R—S—NH—R¹—OH | NH₂—R—S—S—R¹—NH₂ |
| HO—R—NH—S—R¹—OH | H₂N—R—S—O—R¹—NH₂ |
| HO—R—O—S—R¹—OH | NH₂—R—O—S—R¹—NH₂ |
| HO—R—S—O—R¹—OH | NH₂—R—NH—S—R¹—NH₂ |
| H₂N—R—S—NH—R¹—NH₂ | |
| HS—R—S—S—R¹—SH | N₃—R—X—Y—R—N₃ |
| HS—R—O—S—R¹—OS | where X = S, NH, O; Y = S |
| HS—R—S—O—R¹—SH | or |
| HS—R—NH—S—R¹—SH | N₃—R—X—Y—R—N₃ |
| HS—R—S—NH—R¹—SH | where X = S; Y = S, NH, O |

where R and R¹ comprise CH2—CH2, CH2═CH—CH3, CH2═CH-benzene ring, CH2—CH—Cl, or CH2—C(R²)CH3 where R²═H,CH3, etc.

These types of sulfur-oxygen, sulfur-nitrogen bonds undergo thiolytic degradation and are incorporated as latent nuclei in the instant degradable polymeric plastics. The general feature is represented as

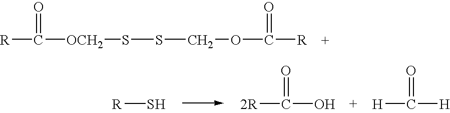

This type of degradation in the family of S—NH, S—O, and S—S and dormant ester bond instant-degradable groups occur to facilitate the instant degradation of the plastics which correspond to the families of regular plastics. The general scheme is:

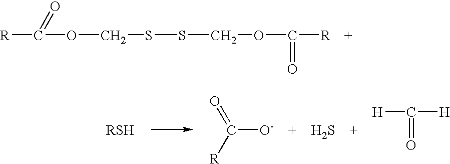

which applies to instant degradable plastics within this family of S—NH, S—O, S—S groups which facilitate instant degradation of such plastic disulfides and sulfenyls.

Additionally, the synthesis of special monomers as building units for radical co-polymerization of instant degradable polystyrene is carried out using allyl mercaptan and benzenethiol or allyl mercaptan and chloramine.

The polymer of the present invention can also be used to produce durable articles. which are not degradable under ambient conditions within the time frame of the useful life of the article. As such, in another aspect of the present invention, the polymer can be used to produce such durable articles. Such articles are, nonetheless, considered to be degradable and are particularly useful because they can be treated to accelerate degradation, encourage polymer solubilization and are instant degradable upon demand. For example, the polymer can be exposed to environmental conditions which accelerate degradation, as for example, yeast releasing thiolic compounds such as glutathione, or the polymer may be collected into reservoirs with specially prepared aqueous solutions containing reducing agents or other non-toxic degrading molecules.

The polymer of the present invention can be characterized as being reductively degradable. As used herein, the term “reductively degradable” refers to a composition in which latent bond nuclei, such as the disulphide bonds in the polymeric macromolecules, comprising the plastics, are subject to nucleophilic reduction, thus producing smaller low molecular weight degradation product molecules.

The polymer of the present invention can be characterized as being chemically degradable under mild aqueous nucleophilic conditions. As used herein, the term “degradable” refers to a composition in which chemical bonds in the molecule are subject to hydrolysis, thus producing smaller molecules. In another embodiment of the present invention, the polymer is biodegradable. The catalytic nucleophilic degradation of the polymers may also be enhanced by chemically controlling stage of degradation in the absence of the degrading nucleophile (nu θ).

The polymer of the present composition may have an average molecular weight of between about 5,000 and about 1,500,000. Appropriate molecular weights will vary according to desired material type as discussed below. The polymer of the present composition can be a homopolymer, a copolymer, or a physical blend of homopolymers and/or polymers. Typically, the polymer of the present materials includes repeating monomer or co-monomer units which are selected from the following group and which polymers are non-toxic and degradable:

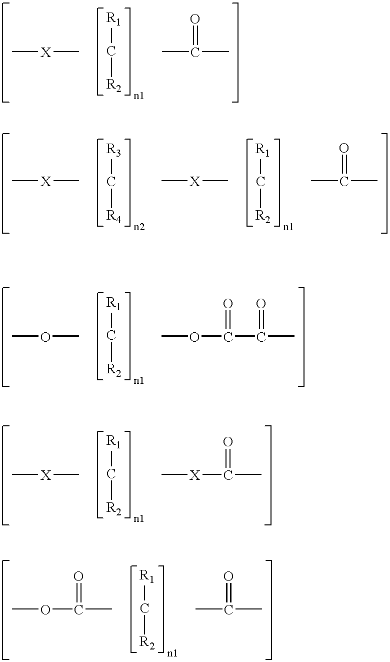

Wherein X is the same or different and is O or NR′ with R′ independently being H, hydrocarbyl, or substituted hydrocarbyl; R1, R2, R3 and R4 can be the same or different and are hydrogen, hydrocarbyl containing 1 to 24 carbon atoms, or substituted hydrocarbyl containing 1 to 24 carbon atoms, and where n1 and n2 can be the same or different and are an integer of from 1-12.

For ethylene, the polymer comprises repeating monomer or co-monomer units derived from CH2—CH2 which have been reacted with the disulphide amino sulfenyl or oxygen sulfenyl moiety. Similarly, as shown above in Tables A to C above, the polymer for propene, styrene, vinyl chloride acrylonitrile, and other, comprise of their sulphide derivatives. Properties of a plastic material are greatly influenced by the shape and chemical make-up of the polymer molecule, for example, resistance to heat, toughness and flexibility are among the properties that may be affected by changes in a plastic's polymer molecule. The term “resin” is often used as a synonym for plastic, resin being the raw, unfinished materials. Plastic is the finished product. Resins are found in various forms, including syrup, powder, flakes, or pellets. Resins may be used by themselves or in combination with additives, including fillers, reinforcing agents, plasticizers, stabilizers, colorants, flame retardants, smoke suppressants or processing aids. The disulfide derivatives of the above products described in the present invention maintain all of the properties of conventional products and in addition, to these properties they retain certain chemical substance solubility qualities which make them instant degradable to facilitate the recycling and processing of used plastics.

Most plastics are described as being thermosetting or thermoplastic. These terms refer to the reaction of a plastic to heat. Thermosetting plastics soften with heat but stay soft only for a short time. They set, or harden, if the heat continues. The process of making thermosetting plastics hard is called curing, which can also be accomplished by chemical means. In curing, the molecules of the plastic link together between chains or cross-links. Once these cross-links are formed the plastic is no longer soft nor can it be re-softened through heating.

Thermoplastic materials also soften with heat but remain soft if the heat continues. They set only when cool and can be softened many times by reheating. In thermoplastics, the molecular chains do not cross-link during the manufacture. Thermoplastics are used for articles that are not subjected to unusual temperature changes, and include acrylonitrile-butadiene-styrene, acetyls, acrylics, cellulosics, fluoropolymers, nylons, polycarbonate, thermoplastic polyester, polyethylene, polyethylene terephthalate, polypropylene, polystyrene, and polyvinyl chloride. The disulfide and sulfenyl derivatives of the above products in the present invention, while retaining the essential properties of instant degradation under mild condition of these products, also provide the above-mentioned advantages of the useful property of instant degradation under mild conditions to plastics products described in the present invention.

The instant-degradable products of the present invention are produced using a variety of molding manufacturing methods including extrusion molding, injection molding, blow molding, compression molding, transfer molding, thermoforming, casting, calendering, low-pressure molding, high-pressure laminating, reaction injection molding, foam molding, or coating. In the following examples, the synthesis and processes for degradation of a few embodiments of the invention are described in detail.

### 6. EXAMPLES

A. Instant Degradable Substitutes for Polyethylene

polyCH₂CH₂—X—Y—CH₂CH₂—X—Y

Where, X═—NH,—O,

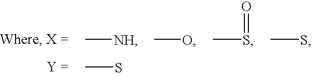

—S,

Y═—S

B. Instant Degradable Substitutes for Polypropylene

polyCH₂CH₂CH₂Y—X—CH₂CH₂CH₂—Y—X

Where, X═—NH,—O,

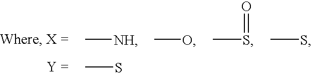

—S

Y═—S

C. Instant Degradable Substitutes for Polyalkane Polymers

mCH₂(CH₂)n CH2—X—Y—CH₂(CH₂)mCH₂—X—Y

Where, X═—NH,—O,—S,

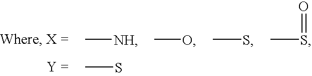

Y═—S.

n=1 to 6 (for ethylene comonomers are derived CH₂—CH₂)

m=1 to 6

D. Synthetic and Degradation Processes

Synthesis of Polyethylene:

HOCH₂CH₂—S—S—CH2CH2OH+Cl₂→Hydroxyethyl disulfide (CH₂Cl₂, 0° C.) 1.

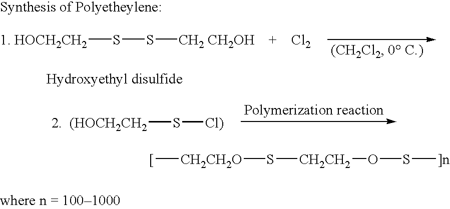

where n=100-1000

E. EXAMPLE: Thiol ethyl ester and Tiol ethyl amide.

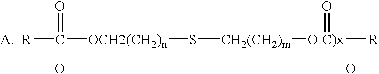

R—C—OCH₂(CH₂)ₙ—S—CH₂(CH₂)ₘ—NH—C)y—R B.

A. Thiol ester and B. Thio ethyl amide

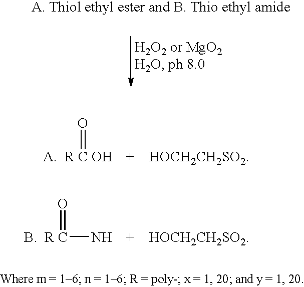

Where m=1-6; n=1-6; R=poly- ; x=1,20; and y=1,20.

Degradation of Instant Degradable Products:

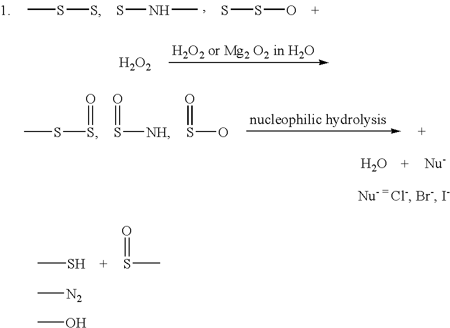

This process describes the preliminary oxidation by hydrogen peroxide, followed by neutralization of the hydrogen peroxide by Fe³⁺ ions, and disposal as non-toxic degradation products.

2. Nucleophilic degradation with RSH, where R is defined as below.

Other Examples follow.

### Example 1

Synthesis of Polyurethane

2 Hydroxyethyldisulphide was mixed with the di-isocyanate monomer:Isophorone Diisocyanate in a volume ratio of 1:1 and in the presence of 1% dibutyltin—dilaureate as catalyst for polymerization of polyurethane. The reaction was allowed to proceed for 3 min. as an exothermic reaction to yield a polyurethane foam. The resulting polyurethane min. as an exothermic reaction to yield a polyurethane foam. The resulting polyurethane foam was completely insoluble in boiling water for 10 min. It dissolved under appropriate controlled reaction conditions with special polymer—degradation—solubility inducing thiol reducing agents. 0.4 gm of sodium mercaptoethylsulphonate in 10 ml distilled water at pH 7.0 was used.

### Example 2

A mixture of 2-Hydroxyethyl disulfide and dihydroxyethylethylamine at a ratio of 1:1 was mixed with isophorone diisocyanate in a volume ratio of 1:1 in the presence of 1% dibutyltin dilaureate, a catalyst for polymerization of polyurethane and other plastics under previously defined conditions.

### Example 3

Synthesis of Monomers as Building Units in Radical Co-polymerization of Instant-degradable Polystyrene.

The following copolystyrene polymers have intrinsic labile latent instant-degradable chemical properties:

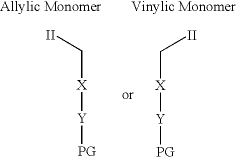

Wherein, PG-Y is a specially designed protective group, X is the chemically labile latent nucleophile with catalytic properties enabling the polymer backbone degradation instant upon chemical demand. Additionally, PG must be preferably aromatic, but can be aliphatic; PG must contribute the appropriate aromatic or aliphatic mechanical properties to the general properties of the polystyrene; Y should contain specific covalent bond qualities in order to allow selective cleavage of the protective group upon command; Y should also be a stable chemical bond during product formulation, handling and use; R′—X—Y—R should be stable to radical degradation during styrene co-polymerization; and monomers and degradation products are environmental-friendly and degradation products are of economic value.

Co-polymerization of monomers to obtain a latent nucleophilic nucleus in the polymer backbone is carried out as follows: styrene, newly designed monomers and a third monomer known to co-polymerize and yield ester bonds in polystyrene are mixed, using appropriate co-polymerizing conditions to obtain a co-polystyrene-ester with appropriate mechanical properties. The resulting polymer contains mechanical properties similar to regular polystyrene due to aromatic contribution of the styrene, the aromatic protecting group, and the aromatic group in the third monomer, which introduces an ester group in the polystyrene background. The newly designed monomer contains latent solubility properties, which upon chemical reaction express the solubility properties, thus enabling facile handling of polymeric rubbish. The newly designed monomer incorporates a latent catalytic nucleophile, which upon specific chemical activation starts catalytic intramolecular hydrolysis of the inserted ester bonds in the general co-polystyrene backbone. The monomers are chosen according to commercial and economic requirements regarding purification of degradation products, which may be reused, for example, as peptidomimetic reagents or other fine chemicals.

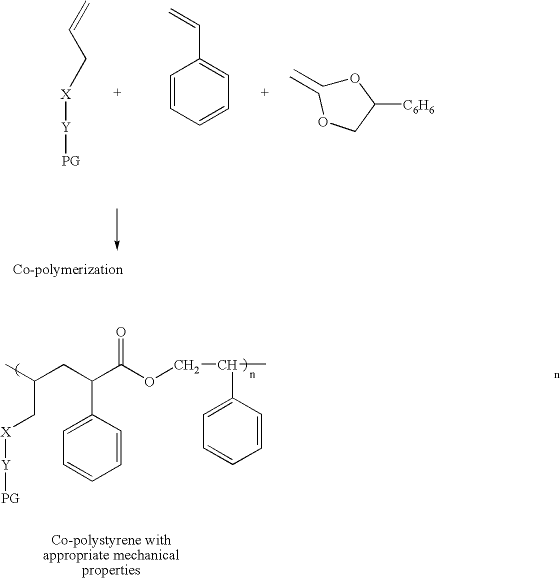

### Example 4

Synthesis of Special Monomers as Building units for Radical co-polymerization of Instant degradable Polystyrene:

1) Preparation and synthesis of specially designed allylic or vinylic monomers in polystyrene co-polymerization with the regular styrene monomer and other desired monomers to obtain a copolystyrene polymer with intrinsic latent—“instant-degradable chemical properties”:

PG-Y=specially designed protective group for inactivating a latent thiol group within the co-polymer, and this latent chemically labile thiol atom, which is directly responsible for the internal intramolecular triggering of the ester bond cleavage, after it has been intermolecularly cleaved by the appropriate activating reagent.

X=chemically labile latent nucleophile with catalytic properties Enabling the polymer backbone degradation to occur instantaneously-upon requirement [like the dissolution of sugar in water].

A. PG=must be preferably aromatic but can be aliphatic

B. PG=must contribute the appropriate aromatic or aliphatic mechanical properties to the general properties of the polystyrene

C. Y=must contain specific covalent bond qualities in order to allow selective cleavage of the protective group upon command.

D. Y=must be a stable chemical bond during product formulation, handling, and use.

E. R′—X—Y—R=must be stable to radical degradation during styrene co-polymerization.

F. monomers and degradation products must be friendly to the environment and degradation products should be of economic interest.

### Example 5

Co-polymerization of Monomers to Obtain a Latent Nucleophilic Nucleus in the Polymer Backbone:

A) a combination of styrene with the newly designed monomers, combined with a third monomer, which is known in the art to co-polymerize and yield ester bonds in polystyrene is mixed.

B) Appropriate co-polymerization conditions are developed in order to obtain a suitable co-polystyrene-ester polymer, with appropriate mechanical properties for product casting and/or other applications.

C) The resulting instant degradable plastic polymer contains:

1. Overall mechanical properties similar to the regular polystyrene due to aromatic contributions of the styrene, the aromatic protecting group, and aromatic group in the third monomer which introduces an ester group in the polystyrene backbone.

2. The newly designed monomer contains “latent solubility properties”, which upon chemical reaction express these solubility qualities in the overall polymer backbone, thus enabling comfortable handling of polymeric rubbish.

3. The newly designed monomer incorporates a latent catalytic nucleophile, which upon specific chemical activation would start catalytic intramolecular hydrolysis of inserted ester bonds in the general co-polystyrene backbone.

4. Monomers are chosen according to commercial and economic requirements regarding obtaining and purification of degradation products-which could be sold, for example as pepidomimetic reagents, or other fine chemicals.

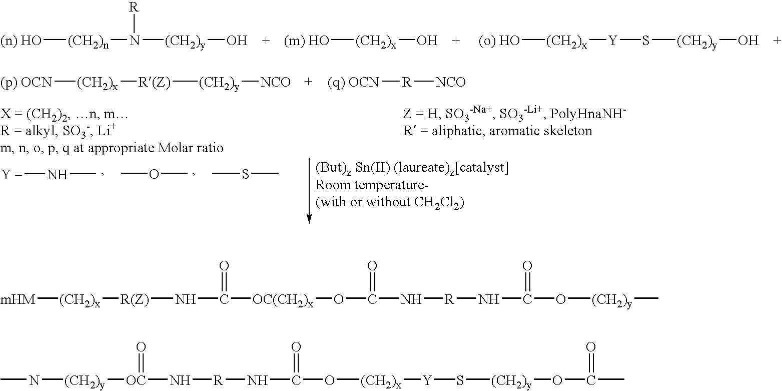

Schematic representation of the preparation of the disulphide plastic product

1. (h) monomer and (p) monomer acquire to the co-polyurethane product improved solubility, upon dissolution in reducing agent solution for instant degradation-but not be soluble under normal aqueous conditions.

2. (m) monomer acquires flexibility properties to mechanical properties of the polymer product.

3. (p) monomer acquires hydrophobic and mechanical properties of the polymer when Z=H; when Z=SO₃—Na+,

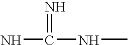

solubility qualities are introduced to the Carbon backbone; modifying these ratios between Z=H, and

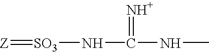

enables to control the overall aqueous and solubility properties or the Instant-Degradable polymer—thus enabling an effective thiol-disulfide cleavage under appropriate conditions.

### Example 6

Five examples in each group of polymers (synthetic and degradation)

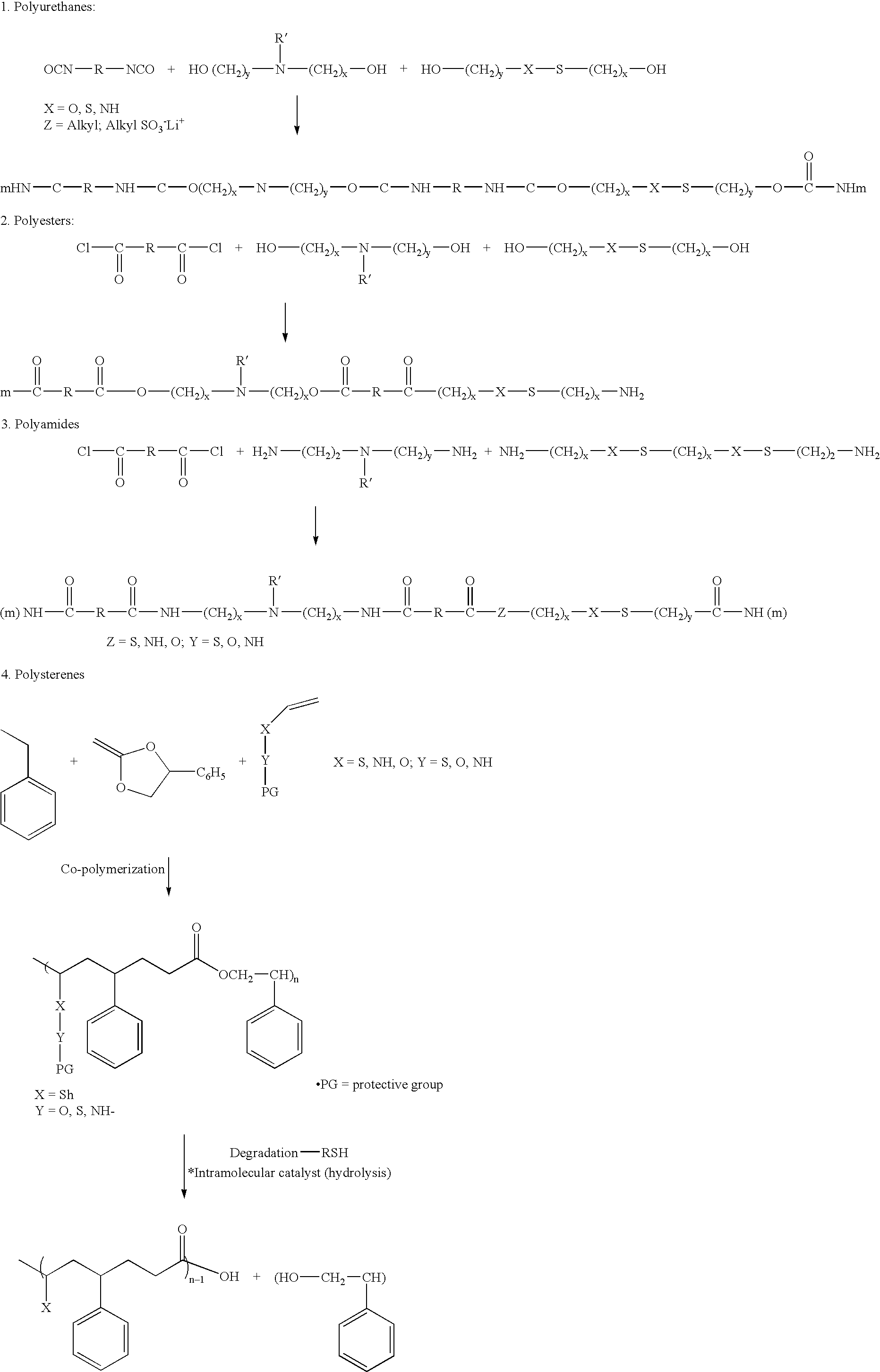

### Example 7

Preparation of Special Monomers Designed as Precursors for the Synthesis of Instant-Degradable Polymers in IDP Plastic Compositions, are Presented Schematically:

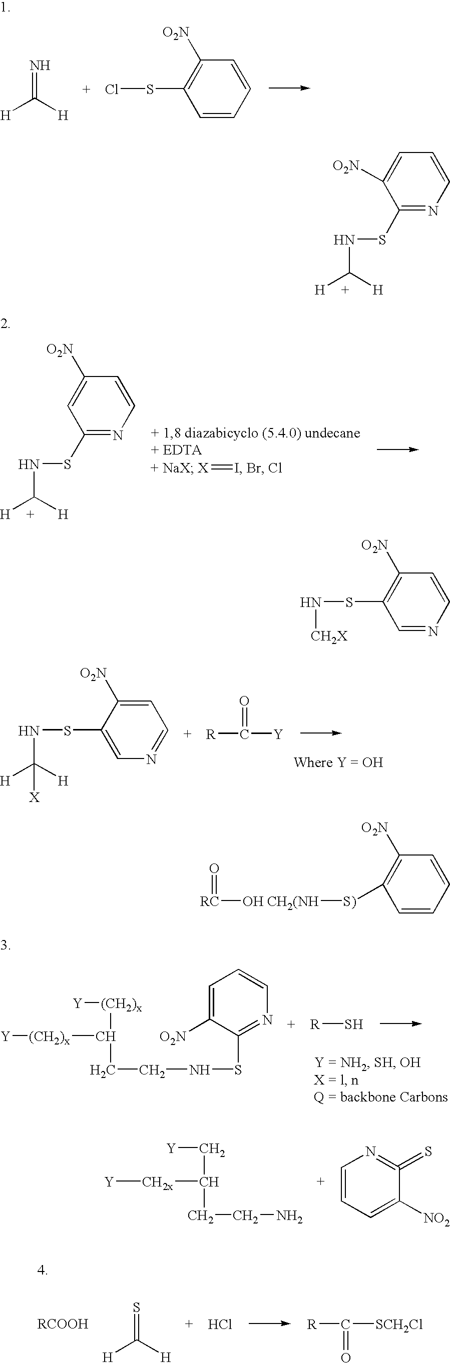

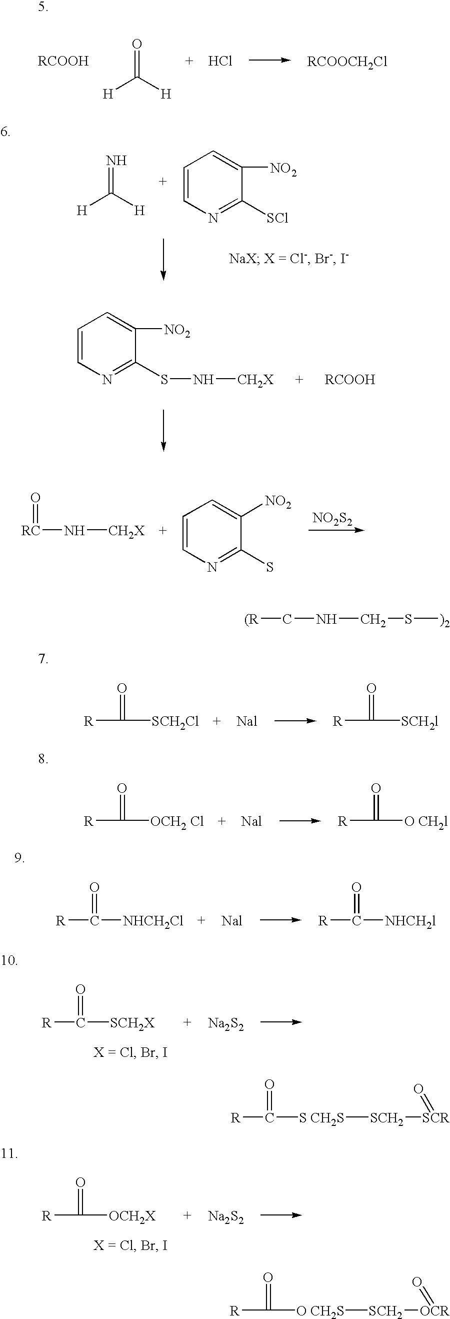

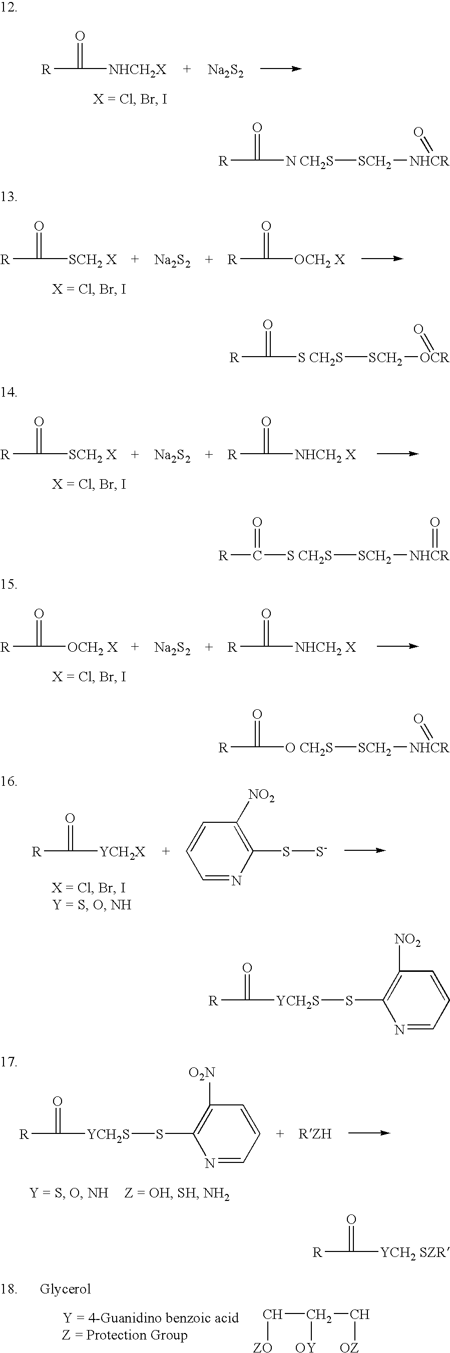

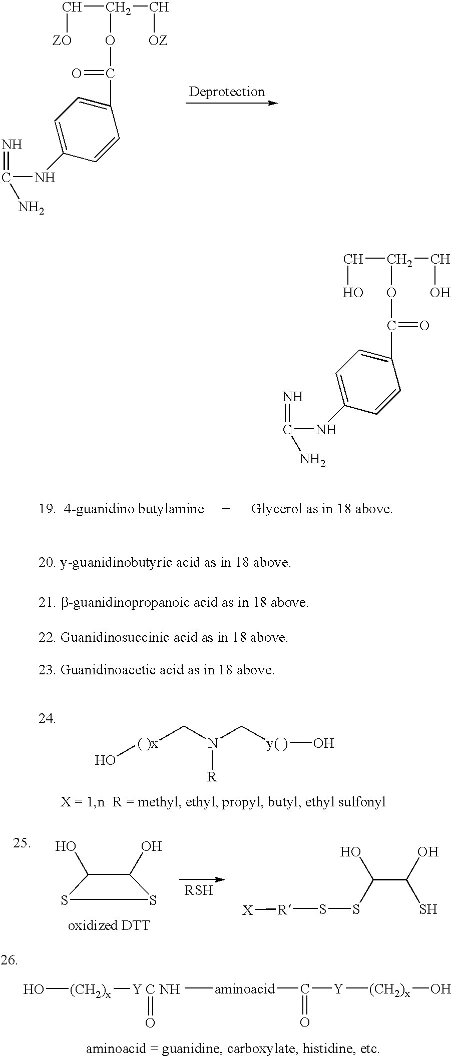

Although the present invention is described in connection with particular preferred embodiments and examples, it is to be understood that many modifications and variations of monomer combinations for preparation of “Instant Degradable Plastics” with suitable formulations can be made in the process and apparatus without departing from the scope to which the inventions disclose herein are entitled. Accordingly it will be understood that these embodiments are illustrative and that the scope of the invention is not limited to them. The present invention is to be considered as including all apparatus, systems and methods encompassed by the appending claims.

What is claimed is:

1. An instant degradable plastic product capable of being degraded into nontoxic by products within a time-span of up to about twenty four hours, said plastic product comprising a hydrolytically degradable polymer and a modifier, wherein said modifier is compatible with said polymer and is non-volatile and non-fugitive and wherein said polymer comprises repeating monomer units selected from the group consisting of
HO—(CH₂)₂—S—S —(CH₂)₂—OH; H₂N—(CH₂)₂—S—S—(CH₂)₂—NH₂
HO—(CH₂)₂—S—NH—(CH₂)₂—OH; HO—(CH₂)₂—S—O—(CH₂)₂—OH
H₂N—(CH₂)₂—S—NH—(CH₂)₂—NH₂; H₂N—(CH₂)₂—S—O—(CH₂)₂—NH₂ 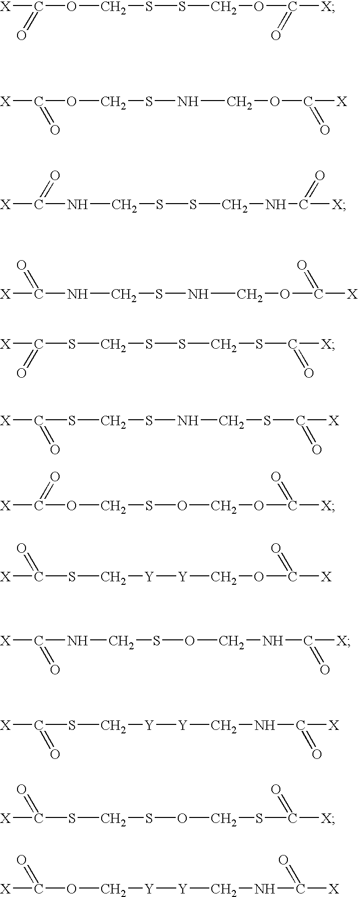
where Y—Y═—S—NH; —O—S—; or 2,2′-Dithiosalicylic acid and its derivatives, and X is CH2—CH2, CH2═CH—CH3, CH2═CH-benzene ring, or CH2═CH—Cl.

2. The instant degradable plastic product according to claim 1, wherein said degradable polymer comprising structures including (—CH2—CH—)n, (CH2—CH2—)n,(—CF₂—CF₂)n wherein n is 1 to 6.

3. The instant degradable plastic product according to claim 1, wherein said instant-degradable polymer comprises at least about 1% to 50% weight, percent repeating units derived from amino-sulfenyl groups, the oxygen-sulfenyl groups, dormant ester bonds, the disulphide groups, methyl thio methyl ester and its derivative, methyl thio ethyl ester or thio ethyl ether.

4. An instant degradable plastic product prepared from one or more components selected from the group consisting of polyurethanes, polyesters, polyamides, polystyrenes, acetals, acrylics, cellulosics, fluoropolymers, nylons, polycarbonate, polyvinyl chloride, polypropylene, polyethylene, a non-toxic modifier monomer with a latent, labile chemical bond—such as a disulfide moiety, an oxygen-sulphenyl moiety, an amino-sulphenyl moiety, a dormant ester bond, methyl thio methyl ester and its derivative, methyl thio ethyl ester or thio ethyl ether.

5. The instant degradable plastic product according to claim 4, which has physical and mechanical properties of conventional plastic products, which are impossible or difficult to instantly degrade within 24 hours in the present state-of-the-art technology.

6. An instant degradable plastic product comprising a chemically degradable polymer from a specially designed modifier, wherein said modifier is compatible with said polymer and is non-volatile and non-fugitive and wherein the said polymer comprises repeating monomer units selected from the group consisting of:

| | |
|---|---|
| HO—R—S—NH—R¹—OH | NH₂—R—S—S—R¹—NH₂ |
| HO—R—NH—S—R¹—OH | H₂N—R—S—O—R¹—NH₂ |
| HO—R—O—S—R¹—OH | NH₂—R—O—S—R¹—NH₂ |
| HO—R—S—O—R¹—OH | NH₂—R—NH—S—R¹—NH₂ |
| H₂N—R—S—NH—R¹—NH₂ | |

where R and R¹ comprise CH2—CH2, CH2═CH—CH3, CH2—CH-benzene ring, CH2—CH—Cl.

7. An instant degradable plastic product comprising a chemically degradable polymer from a specially designed modifier, wherein said modifier is compatible with said polymer and is non-volatile and non-fugitive and wherein the said polymer comprises repeating monomer units selected from the group consisting of:

| | |
|---|---|
| HS—R—S—S—R¹—SH | N₃—R—X—Y—R—N₃ |
| HS—R—O—S—R¹—OS | where X = S, NH, O; Y = S |
| HS—R—S—O—R¹—SH | or |
| HS—R—NH—S—R¹—SH | N₃—R—X—Y—R—N₃ |
| HS—R—S—NH—R¹—SH | where X = S; Y = S, NH, O |

where R and R¹ comprise CH2—CH2, CH2═CH—CH3, CH2═CH-benzene ring, CH2═CH—Cl.

8. The instant degradable plastic product according to claim 5, wherein the product has similar mechanical properties to polyethylene.

9. The instant degradable plastic product according to claim 5, wherein the product has similar mechanical properties to polypropylene.
